(19) United States
(12) Patent Application Publication
(10) Pub. No.: US 2006/0007382 A1
(43) Pub. Date: Jan. 12, 2006

(54) Liquid crystal display apparatus

(76) Inventor: Yutaka Sano, Tottori-shi (JP)

Correspondence Address: KATTEN MUCHIN ROSENMAN LLP, 525 WEST MONROE STREET, CHICAGO, IL, 60661-3693, US

(21) Appl. No.: 11/174,601

(22) Filed: Jul. 6, 2005

(30) Foreign Application Priority Data
Jul. 8, 2004 (JP) 2004-202296

(51) Int. Cl. G02F 1/1345

(52) U.S. Cl. 349/150

(57) ABSTRACT

A liquid crystal display apparatus 10 configured in such manner that multiple TCPs 53A to 53D mounting respective source driver ICs 55A to 55D are provided on the periphery of a liquid crystal display panel 51, where the TCPs neighboring each other are connected via respective connection wires 62A to 62D formed on the liquid crystal display panel 51, and various signals including image data signals and voltages required for driving the liquid crystal display panel and the liquid crystal driver ICs 55A to 55D are supplied from an external circuit board 54 to one TCP at the end of the TCPs, and the various signals and voltage are supplied from the TCP 53A to which the signals and voltage are supplied by the external circuit board sequentially to the adjacent TCPs 53B to 53D, where the source driver ICs 55A to 55D output image data signals except for processed image data signals pertaining to the input image data signals to the next adjacent source driver IC. A liquid crystal display apparatus of such configuration employing the signal transmission system which reduces EMI is thereby provided.

### CROSS-REFERENCE TO RELATED APPLICATIONS

This application claims priority to Japanese Patent Application No. 2004-202296, filed on Jul. 8, 2004, the contents of which are incorporated herein by reference.

### BACKGROUND OF THE INVENTION

1. Field of the Invention

The present invention relates to a liquid crystal display apparatus and more particularly to a liquid crystal display apparatus configured in such manner that multiple TCPs (Tape Carrier Packages) mounting respective liquid crystal driver ICs including gate driver ICs and source driver ICs are connected serially and attached to the periphery of a liquid crystal display panel, utilizing fewer number of wires provided from an external circuit board disposed close to the liquid crystal display panel to the liquid crystal driver ICs mounted on the multiple TCPs to enable easy assembly, and with reduced electromagnetic interference (referred to as EMI hereinafter).

2. Description of the Prior Art

The liquid crystal display panel and control circuit used to drive the liquid crystal display panel in a liquid crystal display apparatus are generally connected via multiple TCPs mounting respective liquid crystal driver ICs. These TCPs include multiple source driver TCPs and gate driver TCPs, and are connected to an external circuit board which supplies the respective TCPs with image data signals, power supply voltages, and the like to cause the respective liquid crystal driver ICs including the gate driver ICs and source driver ICs placed on the respective TCPs to drive the liquid crystal display panel (refer to lines 1 to 13 on the bottom right column of page 1 and FIG. 2 of Japanese Patent Laid-Open Publication No. S62-238684, hereinafter referred to as “Patent Document 1”, and paragraphs [0002] to [0013], and [0043] to [0047] of the claims, and FIG. 1 of Japanese Patent Laid-Open Publication No. 2001-056481), hereinafter referred to as “Patent Document” 2.

The operating principle of the liquid crystal display apparatus of the TCP type as described above is illustrated in FIGS. 3 and 4. FIG. 3A is a schematic view of the liquid crystal display apparatus of the TCP type, while FIG. 3B is a schematic view of a source driver TCP (or a gate driver TCP) mounted on the liquid crystal display apparatus shown in FIG. 3A, and FIG. 4 is a timing chart describing data flow on the respective source driver TCPs.

The liquid crystal display apparatus 50 of the TCP type in FIG. 3 is provided with multiple gate driver TCPs 52 and source driver TCPs 53 which are installed on the periphery of an active matrix type liquid crystal display panel 51 mounting TFTs (Thin Film Transistors), and which provide gate signal lines and source signal lines of the liquid crystal display panel 51 with signals, and an external circuit board 54 which provides the respective TCPs 52, 53 with liquid display panel drive signals such as image data signals, a clock signal, an IC drive power supply voltage, and a counter electrode drive power supply voltage.

The gate driver TCP 52 or the source driver TCP 53 is, for example, provided with the source driver IC 55 on a flexible circuit board 56, signal supply wires 57 which supply the source driver IC 55 with various drive signals for the liquid crystal display panel, and signal output wires 58 which supply the liquid crystal display panel 51 with signals output from the source driver IC 55, as shown in FIG. 3B.

The signal supply wires 57 of the TCPs 52, 53 are respectively electrically connected to terminals on the external circuit board 54 close to the liquid crystal display panel 51, and introduce the liquid crystal display panel drive signals from an image data processing IC 59, a power supply circuit, not shown, and the like provided on the external circuit board 54 to the source driver ICs 55 and the like for example, as shown in FIG. 4. Note that image signals are inputted to the image data processing IC 59 further from an image signal generating apparatus such as a PC, not shown.

A description will now be given of the operating principle of the liquid crystal display apparatus 50 of the TCP type with reference to FIG. 4 while taking the source driver TCP 53 as an example. The liquid crystal display apparatus 50 shown in FIG. 4 is provided with, for example, four source driver TCPs 53A to 53D, and the source driver ICs 55A to 55D are placed respectively on the source driver TCPs 53A to 53D. Note that although multiple gate driver TCPs 52 are connected to the liquid crystal display apparatus 50, only one of them is shown in FIG. 4.

The image signals from the image signal generating apparatus such as a PC are processed by the image data processing IC 59, in that a series of predetermined image data signals (a) to (d) are simultaneously supplied to the source driver ICs 55A to 55D placed on the respective source driver TCPs 53A to 53D via the respective signal supply wires 57A to 57D in synchronism with the clock signal within one scan period. Note that although the image data signals (a) to (d) actually include such number of pulse trains corresponding to the number of source signal lines of the liquid crystal display panel 51 to which the source driver ICs 55A to 55D are connected, only one pulse is shown in FIG. 4 to represent the respective image data signals (a) to (d) to simplify description.

Start pulses are supplied to the respective source driver ICs 55A to 55D at predetermined timing intervals, and the start pulse is supplied to the source driver IC 55A in synchronism with the image data signal (a) when the image data signals are inputted to the source driver IC 55A, and the source driver IC 55A processes the image data signal (a) to respectively supply resulting signals to the predetermined source signal lines connected to corresponding pixels on the liquid crystal display panel 51, for example. Although the above description refers only to the source driver TCPs 53A to 53D, similar processing occurs with respect to the gate driver TCP 52 which carries out predetermined image display on the liquid crystal display panel 51.

In the liquid crystal display apparatus 50 provided with the TCPs 52, 53A to 53D as described above, since the image data signals, the power supply voltages, and the like are independently supplied from the external circuit board 54 to the respective TCPs, it is necessary to dispose a large number of wires on the external circuit board 54. As a result, the manufacturing process of the external circuit board 54, TCPs 52, 53A to 53D, and liquid crystal display panel 51 becomes complicated, thereby entailing cost increases while reducing the level of reliability.

Recently a liquid crystal display apparatus has been developed employing the so-called signal transmission system, which sequentially transmits signals and the like input to and from one TCP to the adjacent TCP, thereby reducing the number of the wires required for the TCPs (refer to Patent Document 2).

To facilitate understanding of the present invention, a description will be given hereafter of a liquid crystal display apparatus 60 employing the signal transmission system disclosed in Patent Document 2 with reference to FIG. 5. Note that FIG. 5 is a schematic plane view of the liquid crystal display apparatus disclosed in Patent Document 2, and accordingly, similar elements referred to in the liquid crystal display apparatus 50 shown in FIG. 4 have been assigned the same reference numerals.

The liquid crystal display apparatus 60 is provided with a liquid crystal display panel 51 of the active matrix type, an external circuit board 54 disposed close to the periphery of the liquid crystal display panel 51, and multiple, for example, four source driver TCPs 53A to 53D which are connected to the external circuit board 54, and arranged on one periphery of the liquid crystal display panel 51.

Source drive ICs are respectively placed on each of the source driver TCPs 53A to 53D, as well as signal input wires used to input signals to the source driver ICs, first signal output lines used to output signals from the source driver ICs to the liquid crystal display panel, second signal output lines used to transmit output signals from the source driver ICs to the adjacent TCP, power supply wires used to drive the source driver ICs, and the like (not shown). The signal input lines of the multiple source driver TCPs 53B to 53D are connected to the second signal output lines of the previous source driver TCP via the connection wires 62B to 62D, respectively, thereby providing a serial connection. The first source driver TCP 53A is connected to the external circuit board 54 via connection wires 62A and a flexible printed circuit board 61. The external circuit board 54 is constituted by the image data processing IC 59, the power supply circuit (not shown), and the like, whereby the image signals transmitted by the image signal generating apparatus such as a PC, not shown, are processed by the image data processing IC 59, and the resulting outputs are supplied to the source driver IC 55A of the first source driver TCP 53A via the signal supply wires 57, the flexible printed circuit board 61, and the connection wires 62A.

Gate driver ICs respectively placed on multiple (only one is shown in FIG. 5) gate driver TCPs 53 are similarly provided on another periphery of the liquid crystal display panel 51, the gate driver ICs being serially connected likewise, whereby the gate driver IC on the first gate driver TCP 52A is connected to other supply wires used for signals and the like, not shown, for the source driver ICs.

In the liquid crystal display apparatus 60, a clock signal, image data signals, timing pulses, and the like supplied from the image data processing IC 59 of the external circuit board 54 to the respective source driver ICs 55A to 55D are entirely similar to those of the liquid crystal display apparatus 50 illustrated in FIG. 4. Namely, respective image data signal input terminals of the source drier ICs 55A to 55D are electrically connected in parallel, such that the image data signals are simultaneously supplied to the source driver ICs 55A to 55D, and the timing pulses are independently supplied to the source driver ICs 55A to 55D, respectively. The image data signals are thus similarly processed as in the case of the liquid crystal display apparatus 50 shown in FIG. 4, and a predetermined image is consequently formed and appears on the liquid crystal display panel 51.

Since it is possible to greatly reduce the number of the wires used to connect the external circuit board 54 and the TCPs on the liquid crystal display apparatus 60, the manufacturing process of the external circuit board 54, TCPs 52, 53A to 53D, and the crystal display panel 51 is simplified, bringing down the manufacturing cost.

Having discovered that a considerable amount of EMI is generated in the liquid crystal display apparatus 60, the inventors of the present invention investigated the causes thereof in various ways, and determined that since the respective image data signal input terminals of the source driver ICs 55A to 55D are electrically connected in parallel and simultaneously supplied with image data signals, the image data signals simultaneously supplied in parallel to the source driver ICs 55A to 55D flow through a long image data signal wire extending across the range from the connection wires 62a on one end to the source driver IC 55D on the other end along the edge of the liquid crystal display panel 51, resulting in EMI generation. Since a large number of wires are provided on the edges of the liquid crystal display panel 51 in the liquid crystal display apparatus 60, it is not possible to enlarge the edges as it would only bring about an increase in “dead” or useless space which could otherwise be used to enhance the image display quality of the liquid crystal display panel 51. It is therefore problematic to employ well-known means for addressing the problem of excessive EMI generation by providing additional shield lines.

### SUMMARY OF THE INVENTION

The present invention is devised to solve the problem of the prior art, and aims to provide a liquid crystal display apparatus employing the so-called signal transmission system where signals and the like inputted to one TCP are sequentially transmitted to the adjacent TCPs, and which electrically processes the image data signals flowing through the image data signal wire to drastically reduce EMI generation.

The abovementioned object of the present invention is attained by providing for a liquid crystal display apparatus with the following configurations. Namely, according to the first aspect of the present invention, a liquid crystal display apparatus is configured in such manner that a plurality of TCPs mounting respective liquid crystal driver ICs including gate driver ICs and source driver ICs are provided on the periphery of a liquid crystal display panel, the neighboring TCPs being connected to each other via a connection wire formed on the liquid crystal display panel, whereby various signals including image data signals and voltages required for driving the liquid crystal display panel and the liquid crystal driver ICs are supplied from an external circuit board to the end of one of the TCPs, and the various signals and voltages are sequentially supplied to and from the TCP to which the signals and voltages are supplied by the external circuit board to the adjacent TCPs, where the source driver ICs output image data signals except for a processed image data signal of the input image data signals to the next adjacent source driver IC.

According to this aspect of the present invention, the source driver ICs are preferably provided with an image data output control circuit which outputs image data signals except for an image data signal corresponding to a start pulse input to the source driver IC to the adjacent source driver IC, whereby the image data output control circuit comprises a circuit that does not transmit the image data signals while the start pulse is being inputted to the source driver IC, and conveys the image data signals while the start pulse is not being inputted to the source driver IC.

Under the above described configuration, the present invention provides the following excellent effects. Namely, since a particular image data signal processed by a predetermined source driver IC is no longer necessary for the other source driver ICs, the number of image data signals outputted from each such source driver IC effectively decreases every time the image data signals pass through the next source driver IC, even if the image data signal wire extending along the edge of the liquid crystal display panel from the TCP on one end to the TCP on the other end is long, such that the generation of EMI caused by the image data signals is drastically reduced.

Under this preferred aspect, since the source driver IC is configured to process the image data signal corresponding to the input start pulse, thereby outputting the resulting signals to the liquid crystal display panel, the source driver IC outputs the image data signals to the adjacent source driver IC except for the image data signal corresponding to the start pulse, thereby easily outputting the required image data signals to the next adjacent source driver IC, by using a simple switch circuit to selectively output only the necessary image data signals.

### BRIEF DESCRIPTION OF THE DRAWINGS

FIG. 1 is a timing chart describing flows of respective data on a source driver IC on respective source driver TCPs of a liquid crystal display apparatus according to the present invention.

FIG. 2 is a block diagram describing the internal circuit configuration of the source driver IC used in the present invention.

FIG. 3A is a schematic view of a liquid crystal display apparatus of the TCP type.

FIG. 3B is a schematic view of a source driver TCP (or gate driver TCP) mounted on the liquid crystal display apparatus of the TCP type represented in FIG. 3A.

FIG. 4 is a timing chart describing flows of respective data on a source driver IC on respective source driver TCPs of the liquid crystal display apparatus of the TCP type.

FIG. 5 is a schematic view of a conventional liquid crystal display apparatus employing the signal transmission system.

### DETAILED DESCRIPTION OF THE PREFERRED EMBODIMENTS

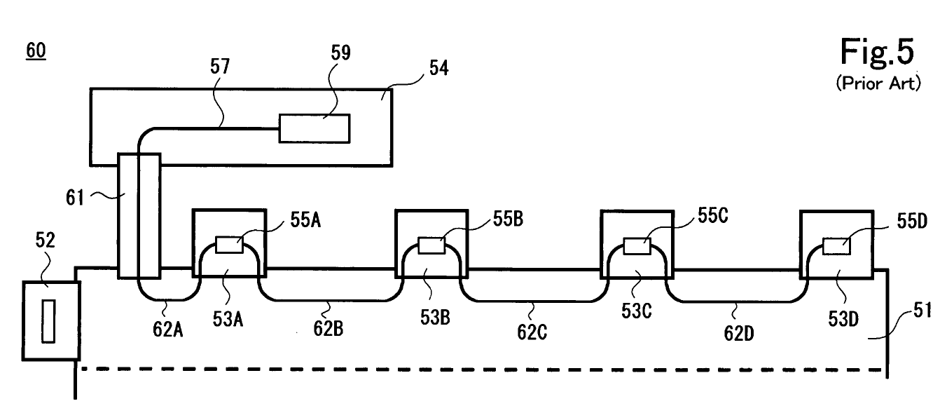

A detailed description will now be given of an embodiment of the liquid crystal display apparatus according to the present invention with reference to accompanying drawings. Note that the application of the present invention is not limited to the embodiment described below pertaining to the liquid crystal display apparatus comprising technical ideas of the present invention, as the present invention is equally applicable to other embodiments within the scope of the claims. In the description written below, elements of the liquid crystal display apparatus of the present invention which correspond to those of the conventional liquid crystal display apparatus 60 shown in FIG. 5 bear the same reference numerals.

### Embodiment 1

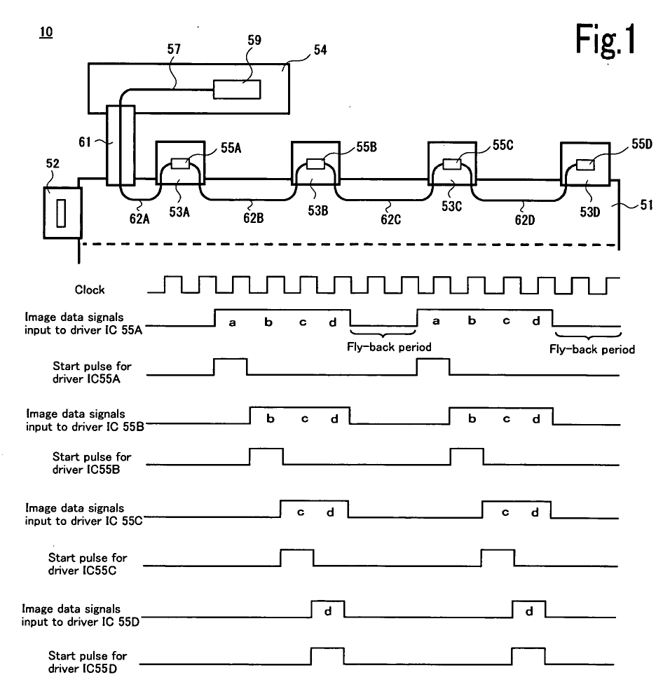

FIG. 1 is a timing chart describing flows of respective data on respective source driver TCPs of a liquid crystal display apparatus 10 according to the embodiment of the present invention. The configuration of the liquid crystal display apparatus 10 shares a lot of common aspects with that of the conventional liquid crystal display apparatus 60 shown in FIG. 5, but differs with the latter in the following respects:
(1) Image data signal input terminals of the source driver ICs mounted on the respective source driver TCPs are not connected with each other in parallel, and the image data signals processed by the previous source driver IC are transmitted to the image data signal input terminal of the adjacent source driver IC, and
(2) The respective source driver ICs process the input image data signals to output signals independently to predetermined source signal lines connected to respective pixels of a liquid crystal display panel as in the prior art, and transmit only image data signals which have not been processed as input image data signals to the adjacent source driver IC.

Namely, a series of image data signals (a) to (d) within one scan period obtained from an image data processing IC 59 of an external circuit board 54 are inputted to the source driver IC 55A provided on a first TCP 53A via signal supply wires 57, a flexible circuit board 61 and connection wires 62A. The source driver IC 55A processes the image data signal (a) in response to a start pulse input thereto to output image data signals to predetermined source signal lines connected to the respective pixels of the liquid crystal display panel 51, and transmits the remaining image data signals (b) to (d), which have not been processed by the source driver IC 55A, to the adjacent source driver IC 55B since the image data signal (a) is not necessary for the other source driver ICs.

The source driver IC 55B processes the image data signal (b) in response to a start pulse input thereto to output image data signals to the source signal lines of the liquid crystal display panel 51, and transmits the remaining image data signals (c) and (d), which have not been processed by the source driver IC 55B, to the adjacent source driver IC 55C since the image data signal (b) is not necessary for the other source driver ICs, and similar processing is carried out sequentially on the source driver ICs 55C and 55D.

With this configuration, the image data signals (a) to (d) flow through the connection wires 62A, the image data signals (b) to (d) flow through the connection wires 62B, the image data signals (c) and (d) flow through the connection wires 62C, and the image data signal (d) flows through the connection wires 62D. Although all the image data signals (a) to (d) flow through the connection wires 62A to 62D of the liquid crystal display apparatus 60 employing the conventional signal transmission system shown in FIG. 5, the EMI generated in the connection wires 62A to 62D drastically decreases since the number of image data signals flowing through the connection wires 62A to 62D sequentially decreases.

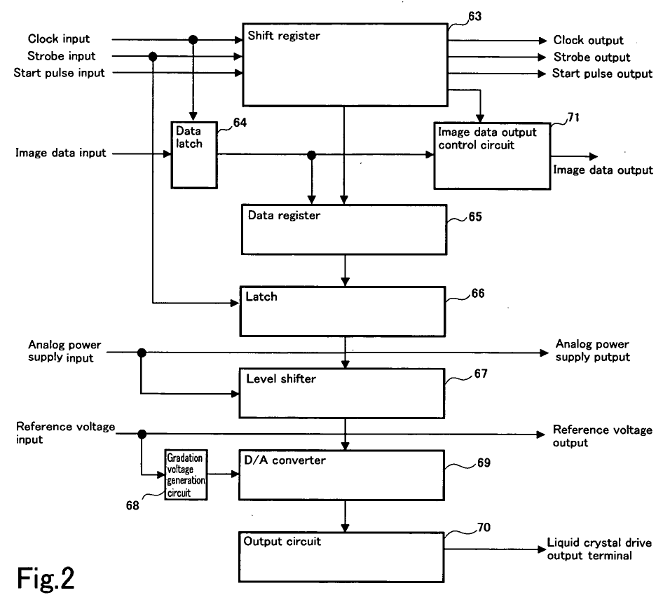

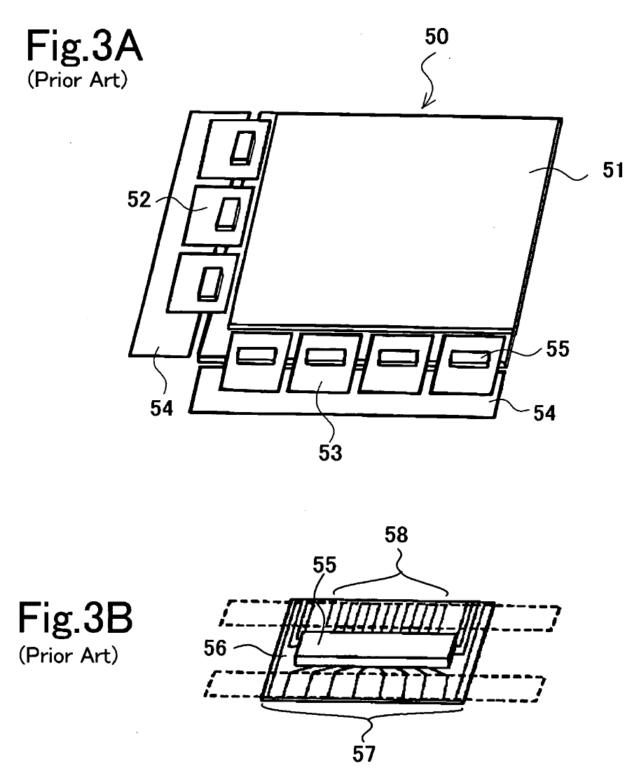

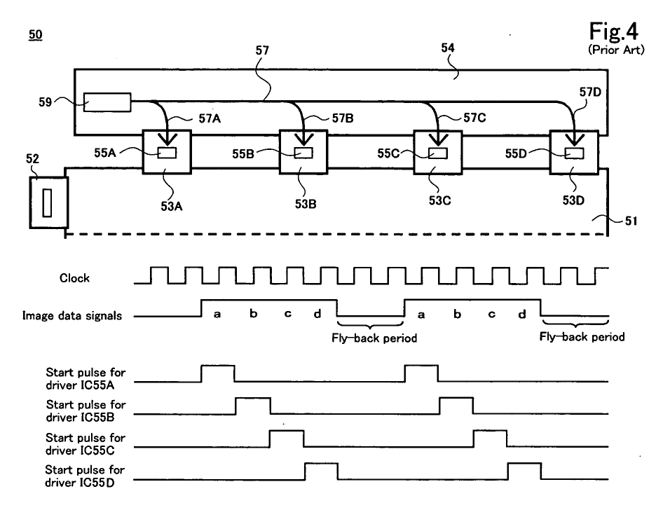

A description will now be given of a specific example of the source driver IC used in the present embodiment with reference to FIG. 2. FIG. 2 is a block diagram describing the internal circuit configuration of the source driver IC used in the present invention. Like the conventional source driver IC, the source driver IC of the present invention is provided with a shift register 63, a data latch 64, a data register 65, a latch 66, a level shifter 67, a gradation voltage generation circuit 68, a D/A converter 69, and an output circuit 70 as well as an image data output control circuit 71, which selectively outputs predetermined image data of input image data to the next stage, as a unique constitution.

The shift register 63 carries out a shift operation in synchronization with a clock signal by selecting bits used to sample the image data based on the predetermined start pulse input, while a data latch 64 temporarily stores the input image data and thereafter transmits the stored image data to the data register 65. The data register 65 samples predetermined image data from the image data input coming from the data latch 64 by way of time-sharing according to instructions made by the shift register 63, and transmits the sampled image data to a latch 66. The latch 66 latches the data from the data register 65 at once according to a strobe input, and transmits the latched data to the level shifter 67. The level shifter 67 shifts the data latched by the latch 66 to the power supply level of an analog circuit section, and outputs the shifted data to a D/A converter 69. The gradation voltage generation circuit 68 generates a voltage corrected by the y correction by dividing a reference voltage input externally by means of an internal ladder register, and transmits the resulting voltage to the D/A converter 69. The D/A converter 69 converts the digital image signal input from the level shifter 67 to an analog signal based on the voltage corrected by the y correction from the gradation voltage generation circuit 68, and transmits the resulting analog signal to the output circuit 70. The output circuit 70 is a voltage follower comprising an operational amplifier and an output buffer, and outputs an analog signal to a liquid crystal driver output terminal.

The image data output control circuit 71 outputs to the adjacent source driver IC the image data signals of the image data latched by the data latch 64 which are not stored into the data register 65, per timing instruction given by the shift register 63. In this regard, the image data output control circuit 71 may be constituted by a simple circuit such as a switch circuit, which does not transmit the image data signals while the start pulse is being inputted to the source driver IC, and conveys the image data signals while the start pulse is not being inputted to the source driver IC.

Since the source driver IC used in the present embodiment outputs the image data signals except for the processed image data signal of the input image data signals to the next adjacent source driver IC, such that the quantity of data transmitted by the image data signals sequentially decreases along the source driver ICs serially connected in multiple stages even if the image data signal wire is long, the quantity of data carried by the image data signals consequently sequentially decreases as the distance from the input end of the image data signals increases, thereby resulting in a drastic decrease in the generation of EMI.

What is claimed is:

1. A liquid crystal display apparatus configured in such manner that a plurality of tape carrier packages (referred to as “TCPs” hereinafter) mounting respective liquid crystal driver ICs including gate driver ICs and source driver ICs are provided on the periphery of a liquid crystal display panel, the said neighboring TCPs being connected to each other via a connection wire formed on the said liquid crystal display panel, whereby various signals including image data signals and voltages required for driving the said liquid crystal display panel and the said liquid crystal driver ICs are supplied from an external circuit board to one TCP at the end of the said TCPs, and the various signals and voltages are supplied from such TCP to which the signals and voltages are supplied by the said external circuit board sequentially to the TCP adjacent thereto, wherein:
the said source driver IC outputs image data signals except for the processed image data signals of the input image data signals to the source driver IC adjacent thereto.

2. The liquid crystal display apparatus according to claim 1, wherein the said source driver IC is provided with an image data output control circuit, and the said image data output control circuit outputs image data signals except for image data signals corresponding to start pulse inputs to the said source driver IC to the source driver IC adjacent thereto.

3. The liquid crystal display apparatus according to claim 2, wherein the said image data output control circuit comprises a circuit that does not transmit image data signals while the start pulses are being inputted to the said source driver IC, and conveys the image data signals while the start pulses are not being inputted to the said source driver IC.
